(19) United States
(12) Patent Application Publication
(10) Pub. No.: US 2017/0276517 A1
(43) Pub. Date: Sep. 28, 2017

(54) MAGNETIC SENSOR, SENSOR ARRANGEMENT AND METHOD FOR DETERMINING THE POSITION OF A MAGNETICALLY ACTIVE ELEMENT

(71) Applicant: Continental Teves AG & Co. oHG, Frankfurt (DE)

(72) Inventor: Heinrich Acker, Schwalbach (DE)

(21) Appl. No.: 15/504,755

(22) PCT Filed: Sep. 15, 2015
(86) PCT No.: PCT/EP2015/071114

§ 371 Date: Feb. 17, 2017

(30) Foreign Application Priority Data
Sep. 18, 2014 (DE) 10 2014 218 754.0

(51) Int. Cl. G01D 5/20

(52) U.S. Cl. CPC G01D 5/2013

(57) ABSTRACT

A magnetic sensor, a sensor arrangement including a magnetic sensor of this type, and a method for determining the position of a magnetically active element. In the sensor, multiple measuring coils are connected in series along a path, such that the position of a magnetically active element along the path can be measured.

### CROSS REFERENCE TO RELATED APPLICATIONS

This application is the U.S. National Phase Application of PCT International Application No. PCT/EP2015/071114, filed Sep. 15, 2015, which claims priority to German Patent Application No. 10 2014 218 754.0, filed Sep. 18, 2014, the contents of such applications being incorporated by reference herein.

### FIELD OF THE INVENTION

The invention relates to a magnetic sensor for detecting a magnetically active element. The invention further relates to a sensor arrangement comprising such a magnetic sensor. In addition, the invention relates to a method for determining the position of a magnetically active element.

### BACKGROUND OF THE INVENTION

Magnetic sensors can be designed in various ways and can be used for various detection tasks. They can be used in particular to detect the presence of a magnetically active element, wherein a magnetically active element typically comprises an element which can vary magnetic and/or electrical properties of components located in the surroundings thereof.

### SUMMARY OF THE INVENTION

An aspect of the invention provides an alternative magnetic sensor compared to known magnetic sensors, which is improved, for example, in certain properties. A further aspect of the invention provides a sensor arrangement with such a magnetic sensor. In addition, an aspect of the invention provides a method for detecting a magnetically active element using such a magnetic sensor.

An aspect of the invention relates to a magnetic sensor for detecting a magnetically active element. The magnetic sensor has a multiplicity of measuring coils. This can comprise a number of, for example, two, three, four, five, eight, or an arbitrary different number of measuring coils, wherein at least two measuring coils are provided. Each measuring coil has a magnetic core assigned to it. The respective magnetic cores are preferably each disposed inside a measuring coil, which is assigned to the magnetic core. The measuring coils are disposed along a path. This can, for example, be straight or else curved. The measuring coils are connected electrically in series along the path. Furthermore, the measuring coils have respective inductances, which increase in one direction along the path. This can in particular mean that a respective inductance of a measuring coil disposed in a specific direction behind another measuring coil is greater than the inductance of the other measuring coil.

By means of the magnetic sensor, a particularly simple, exact, and reliable detection of a magnetically active element is possible. For this purpose, parameters explained further below, for example, a total inductance of the magnetic sensor can be read out, wherein the position of the magnetically active element along the path can typically also be inferred.

The measuring coils are preferably suitable for SMD assembly and/or compatible with SMD assembling machines. This allows a simple manufacture of a magnetic sensor according to the invention. Particularly preferably the magnetic sensor is accordingly fitted by means of surface-mounted-device (SMD) technology. Inductances of this type frequently have small spatial extension, which has proved advantageous for the magnetic sensor according to the invention.

Preferably the magnetic sensor is configured to produce a common output signal depending on a position of the magnetically active element along the path. In particular, it is preferred in this case if the common output signal comprises a total inductance. Here this is a total inductance of the measuring coils connected in series. However, it is understood that other common output signals can also be used, for example, a resonance frequency when the measuring coils connected in series are supplemented with a capacitor to form a resonant circuit, or also a loss angle of the measuring coils connected in series. It is understood that two such common output signals can also be used in order to read out the magnetic sensor.

The magnetically active element is preferably a ferromagnetic highly permeable body, an electrically conductive body, or a permanent magnet. If a ferromagnetic highly permeable body is arranged in the vicinity of a measuring coil, the body acts as a flux conductor. The flux through the body depends on position and/or angle of the body relative to the inductance. The inductance value is thereby varied. If an electrically conductive body is disposed in the vicinity of a measuring coil, an eddy current flows through the body due to induction, wherein this eddy current depends on position and/or angle of the body relative to the inductance. Inductance value and loss resistance are thereby varied.

If a permanent magnet is disposed in the vicinity of a sensor inductance, the magnet produces a flux, which can saturate a ferromagnetic, highly permeable body, which is disposed in such a manner that it acts as the core of a measuring coil. The flux through the body, for example therefore through the core of a measuring coil, depends on position and/or angle of the magnet relative to the inductance. As a result, predominantly the inductance value is varied.

In one aspect the respective magnetic cores have no remnant magnetization. This can mean, for example that they only have a magnetization of a negligible value, which plays no role for a measurement. If the respective magnetic cores have no magnetization, they have a particularly high permeability since the curve of magnetic flux density B as a function of a magnetic field strength H at this point has a particularly high slope. This enables a particularly good and exact measurement.

In one aspect the measuring coils are disposed on a printed circuit board, a leadframe, or a molded interconnected devices (MID) carrier. An MID carrier is in particular understood as a spatially injection-molded circuit carrier. Such designs have proved advantageous.

According to one embodiment, each measuring coil is constructed of deposited and structured and/or laminated layers of a metal, in particular a light metal, copper, or an alloy with nickel and/or palladium, and a ferromagnetic material. Such a design' has proved particularly advantageous in particular in regard to the manufacture. In this case, for example, a technology such as for a multilayer ceramic capacitor (MLCC) can be used.

In one aspect of the invention the ferromagnetic material may comprise a highly permeable material.

Typically little stray flux develops in such components, instead as a result of a closed magnetic circuit, a high flux is established in the highly permeable material, with the result that a high inductance value can be achieved in small space.

Such measuring coils can, for example, also be designed as SMD ferrite pearls, SMD multiplayer inductances, or also as wire-wound SMD inductances. These SMD components typically also contain a core.

In one aspect the measuring coils are spaced so closely apart from one another that during movement of a magnetically active element along the path, a characteristic curve of the total inductance is obtained, which is monotonically increasing or decreasing at least over half of the path, preferably over at least three quarters of the path. This enables an unambiguous assignment of a measured value of the total inductance to a position of the magnetically active element along the path. It is understood that here instead of the total inductance, the common output signals described further above, for example, can also be used, so that these have a monotonically increasing or decreasing characteristic curve. The monotonicity mentioned here is preferably a strict monotonicity.

An aspect of the invention further relates to a sensor arrangement. The sensor arrangement comprises a magnetic sensor according to the invention. In this case, all the described designs and variants can be used. The explained advantages apply accordingly. The sensor arrangement further comprises a magnetically active element and a guide for the magnetically active element. The guide is configured in such a manner that the magnetically active element is movable along the path.

By means of the sensor arrangement according to an aspect of the invention, it is possible to determine the position of the magnetically active element, which is part of the sensor arrangement, along the path predefined by the magnetic sensor. The guide need not necessarily belong exclusively to the sensor, for example, it can also be designed as part of another component which would be present even without the sensor. The sensor can advantageously be used, for example, to measure a distance or an angle in certain situations.

In one aspect the magnetically active element has an actuating member, by means of which it is movable from outside the guide along the path. This actuating member can then be connected, for example outside the sensor, to a component whose movement relative to another component is to be measured. If the remainder of the sensor arrangement is connected to the other component, the movement of the component to be measured via the actuating member can be transferred to the magnetically active element, whose position can in turn be measured in the manner described above.

In one aspect the magnetically active element is a ferromagnetic highly permeable body, an electrically conductive body, or a permanent magnet. With regard to the possible details and modes of operation, reference is made on this matter to the explanations further above.

When using a ferromagnetic highly permeable body or an electrically conductive body, conventional SMD inductances have proved to be particularly advantageous as measuring coils with an open magnetic circuit. On the other hand, SMD ferrite pearls and SMD multilayer inductances with a closed magnetic circuit have proved particularly advantageous for use in connection with a permanent magnet.

It is understood that in principle, a plurality of magnetically active elements, in particular differently designed magnetically active elements, can also be used in a sensor arrangement according to the invention. For example, two or more different magnetically active elements but in each case configured according to one of the alternatives listed above can be used.

In one aspect the sensor arrangement further comprises a measuring circuit for determining a total inductance of the measuring coils. This enables an integrated readout of the sensor arrangement by its own measuring circuit. In this case, in particularly proven designs can be used.

The total inductance can be interpreted in this case as a complex impedance with two real parameters. For example, here this can be inductance and series resistance, magnitude of the impedance and loss angle, or inductance and Q factor. A measuring circuit is in this case preferably capable of determining at least one of these parameters or both together.

An aspect of the invention further relates to a method for determining the position of a magnetically active element, wherein the method comprises the following steps:
arranging the magnetically active element above a magnetic sensor according to the invention along the path,
measuring a total inductance of the measuring coils, and
determining the position based on the total inductance.

By means of a method according to an aspect of the invention, a magnetic sensor according to the invention can preferably be used to determine a position of a magnetically active element. With regard to the magnetic sensor, all the designs and variants described further above can be used. Explained advantages apply accordingly.

It is understood that instead of the total inductance, another quantity can also be measured and/or evaluated, which is preferably related to the total inductance, for example, is dependent on it.

The magnetically active element can in particular be designed according to at least one of the designs as explained further above.

In one aspect the method further comprises a step of varying the position of the magnetically active element along the path. In such a step the new position of the magnetically active element thereby formed can particularly advantageously be measured in the manner described above.

In one aspect the magnetically active element is a ferromagnetic highly permeable body, an electrically conductive body, or a permanent magnet. For further details and modes of operation on this matter reference is made to the above explanations.

According to another embodiment, the sensor is part of a sensor arrangement according to the invention. In this case, all designs and variants of the sensor arrangement described further above can be used. Explained advantages apply accordingly.

By integrating the sensor in a sensor arrangement, the advantages of a sensor arrangement according to aspects of the invention described further above for the method according to an aspect of the invention can be utilized.

### BRIEF DESCRIPTION OF THE DRAWINGS

The person skilled in the art will deduce further features and advantages from the exemplary embodiment described hereinafter with reference to the appended drawing.

In the figures:

FIG. 1: shows a sensor arrangement with a sensor,

FIG. 2: shows a characteristic curve of the sensor from FIG. 1.

### DETAILED DESCRIPTION OF THE PREFERRED EMBODIMENTS

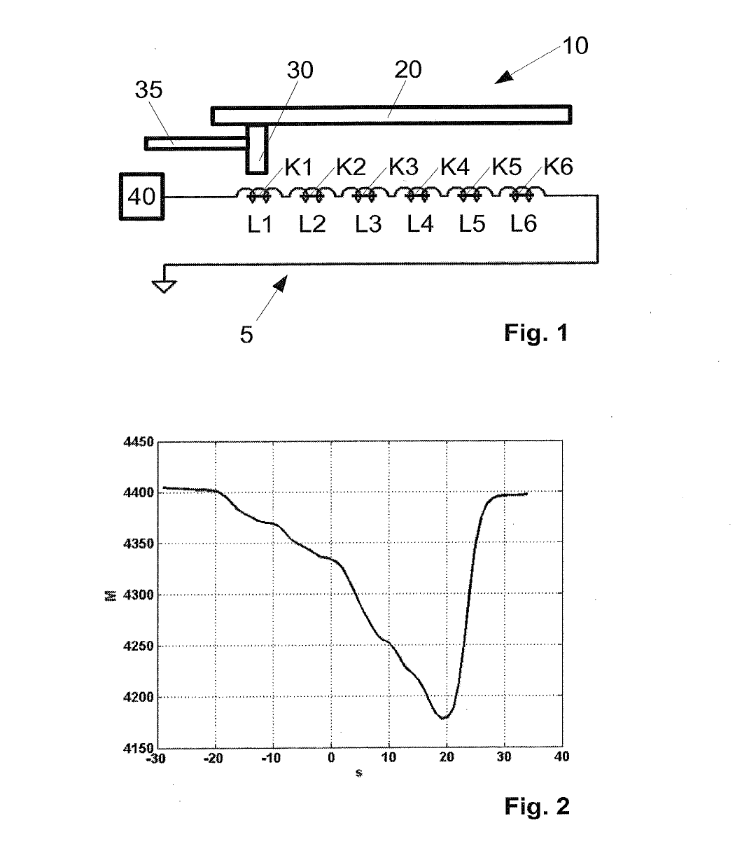

FIG. 1 shows a sensor arrangement 10 according to one exemplary embodiment. The sensor arrangement 10 has a sensor 5.

The sensor 5 has a total of six measuring coils L1, L2, L3, L4, L5, L6, which are mounted on a printed circuit board (not shown). Each of the measuring coils has one core K1, K2, K3, K4, K5, K6 assigned in each case. The cores K1, K2, K3, K4, K5, K6 are not magnetized in the basic state. The measuring coils L1, L2, L3, L4, L5, L6 are connected electrically in series as shown. They are disposed geometrically along a path predefined by their arrangement, which path is straight. For the respective inductances, which are designated the same as the measuring coils, the relationship L1<L2<L3<L4<L5<L6 applies. The inductances therefore increase from left to right. In the present case, each measuring coil has an inductance which is 50% higher compared with the inductance of the measuring coil directly on the left of it.

The sensor arrangement 10 further comprises a guide 20. The guide 20 is disposed directly above the path predefined by the measuring coils L1, L2, L3, L4, L5, L6. A magnetically active element in the form of a permanent magnet 30 is disposed on the guide 20. The permanent magnet 30 can be displaced in the guide 20 along the path.

The permanent magnet 30 is connected to an actuating member in the form of a rod 35. The rod 35 can be connected to a component whose movement relative to the sensor 5 is to be measured. A movement of the component (not shown) is transmitted via the rod 35 to the permanent magnet 30, which moves accordingly along the path in the guide 20.

The sensor arrangement 10 further comprises a measuring circuit 40, which is designed in a known manner. The measuring circuit 40 is configured to measure the total inductance of the measuring coils L1, L2, L3, L4, L5, L6 connected in series.

FIG. 2 shows a typical characteristic curve of the sensor 5 from FIG. 1. A dimensionless quantity s is plotted on the horizontal axis as a measure for the displacement of the permanent magnet 30 along the path. A likewise dimensionless quantity M is plotted on the vertical axis as a measure for a value measured by the measuring circuit 40. Here this comprises a value which is calculated from the total inductance of the sensor 5. As shown, the characteristic curve is monotonically decreasing for values between about s=−20 and s=20. In this range, the respective position of the permanent magnet 30 along the path can be determined directly from the value of M. In this range of the characteristic curve, the sensor 5 is thus suitable for a direct determination of the position of the permanent magnet 30 along the path. As a result, in particular a position of a component connected to the permanent magnet 30 via the rod 35 can be determined. Thus, the sensor 5 can be used as part of the sensor arrangement 10 for measuring relative movements.

The claims pertaining to the application do not constitute any dispensing with achieving further protection.

If it is established in the course of the method that a feature or a group of features is not absolutely necessary, an attempt is already being made by the applicant to formulate at least one independent claim which no longer has the feature or the group of features. This can for example comprise a sub-combination of a claim provided at the filing date or a sub-combination of a claim provided at the filing date restricted by further features. Such claims or feature combinations to be newly formulated should be understood as covered by the disclosure of this application.

It should be further pointed out that configurations, features, and variants of the invention, which are described in the various explanations or exemplary embodiments and/or shown in the figures, can be arbitrarily combined with one another. Individual or several features can be arbitrarily exchanged for one another. Feature combinations formed from these should be understood as covered by the disclosure of this application.

Back-references in dependent claims are not to be understood as dispensing with achieving an independent specific protection for the features of the back-related subclaims. These features can also be combined arbitrarily with other features.

Features which are merely disclosed in the description or features which are disclosed in the description or in a claim only in connection with other features can fundamentally be of independent importance essential to the invention. They can therefore be incorporated individually in the claims for delimitation from the prior art.

1. A magnetic sensor for detecting a magnetically active element, comprising:
which has a multiplicity of measuring coils,
wherein each measuring coil has a magnetic core assigned to it,
wherein the measuring coils are disposed along a path,
wherein the measuring coils are connected electrically in series along the path, and
wherein the measuring coils have respective inductances, which increase in one direction along the path.

2. The magnetic sensor as claimed in claim 1,
which is configured to produce a common output signal depending on a position of the magnetically active element along the path.

3. The magnetic sensor as claimed in claim 2,
wherein the magnetically active element is
a ferromagnetic highly permeable body,
an electrically conductive body, or
a permanent magnet.

4. The magnetic sensor as claimed in claim 1,
wherein the respective magnetic cores have no remnant magnetization.

5. The magnetic sensor as claimed in claim 1,
wherein the measuring coils are disposed on a printed circuit board, a leadframe, or a molded interconnected devices carrier.

6. The magnetic sensor as claimed in claim 1,
wherein each measuring coil is constructed of deposited and structured and/or laminated layers of a metal, in particular a light metal, copper, or an alloy with nickel and/or palladium, and a ferromagnetic material.

7. The magnetic sensor as claimed in claim 1,
wherein the measuring coils are spaced so closely apart from one another that during movement of a magnetically active element along the path a characteristic curve of the total inductance is obtained, which is monotonically increasing or decreasing at least over half of the path.

8. A sensor arrangement, comprising:
a magnetic sensor as claimed in claim 1,
a magnetically active element, and
a guide for the magnetically active element,
wherein the guide is configured in such a manner that the magnetically active element is movable along the path.

9. The sensor arrangement as claimed in claim 8,
wherein the magnetically active element has an actuating member, by which the magnetically active element is movable from outside the guide along the path.

10. The sensor arrangement as claimed in claim 8,
wherein the magnetically active element is
a ferromagnetic highly permeable body,
an electrically conductive body, or
a permanent magnet.

11. The sensor arrangement as claimed in claim 8,
further comprising a measuring circuit for determining a total inductance of the measuring coils.

12. A method for determining the position of a magnetically active element, the method comprising:
arranging the magnetically active element above the magnetic sensor as claimed in claim 1 along the path,
measuring a total inductance of the measuring coils, and
determining a position of the magnetically active element based on the total inductance.

13. The method as claimed in claim 12,
further comprising varying the position of the magnetically active element along the path.

14. The method as claimed in claim 12,
wherein the magnetically active element is
a ferromagnetic highly permeable body,
an electrically conductive body, or
a permanent magnet.

15. The method as claimed in claim 12,
wherein the sensor is part of a sensor arrangement comprising:
the magnetic sensor;
the magnetically active element; and
a guide for the magnetically active element,
wherein the guide is configured in such a manner that the magnetically active element is movable along the path.

16. The magnetic sensor as claimed in claim 1,
which is configured to produce a common output signal, in particular a total inductance, depending on a position of the magnetically active element along the path.

17. The magnetic sensor as claimed in claim 1, wherein each measuring coil is constructed of deposited and structured and/or laminated layers of a light metal, copper, or an alloy with nickel and/or palladium, and a ferromagnetic material.

18. The sensor arrangement as claimed in claim 9, wherein the magnetically active element is a ferromagnetic highly permeable body, an electrically conductive body, or a permanent magnet.

19. The magnetic sensor as claimed in claim 1, wherein the measuring coils are spaced so closely apart from one another that during movement of a magnetically active element along the path a characteristic curve of the total inductance is obtained, which is monotonically increasing or decreasing at least least three quarters of the path.
